(19) United States
(12) Patent Application Publication
(10) Pub. No.: US 2013/0151299 A1
(43) Pub. Date: Jun. 13, 2013

(54) METHOD AND SYSTEM FOR OPTIMIZING THE DELIVERY OF ENVIRONMENTAL MANAGEMENT TRAINING

(71) Applicant: Conrad F. Vernon, Issaquah, WA (US)

(72) Inventor: Conrad F. Vernon, Issaquah, WA (US)

(21) Appl. No.: 13/492,700

(22) Filed: Jun. 8, 2012

Related U.S. Application Data
(63) Continuation of application No. 12/687,020, filed on Jan. 13, 2010, now abandoned.

(51) Int. Cl. G09B 23/00

(52) U.S. Cl. CPC G09B 23/00; G06Q 10/063114
USPC 705/7.15; 434/276

(57) ABSTRACT

A method and system that optimizes the delivery of training materials to an organization that seeks to implement an environmental management system (EMS) meeting the requirements of a standard (such as ISO 14001-2004). The system generates an optimized set of training materials for an organization based on two analyses. The system presents gap analysis questions pertaining to the elements of the standard. Responses received to the gap analysis questions are used to calculate a gap analysis score with respect to each of the elements. The system also presents aspects and impacts questions in a cascaded fashion, meaning that certain aspects and impacts questions are presented based at least in part on responses received to previous aspects and impacts questions. The system generates optimized training materials for the organization by filtering a set of training modules based on the gap analysis scores and the aspects and impacts responses.

### CROSS-REFERENCE TO RELATED APPLICATIONS

This application is a continuation of U.S. patent application Ser. No. 12/687,020 filed Jan. 13, 2010, entitled METHOD AND SYSTEM FOR OPTIMIZING THE DELIVERY OF ENVIRONMENTAL MANAGEMENT TRAINING, and hereby incorporated by reference in its entirety as if fully set forth herein.

### BACKGROUND

An organization may control its environmental impacts and promote sound development by implementing an environmental management system (“EMS”). An EMS addresses the immediate and long-term environmental consequences of an organization's products, services, facilities, and processes. Organizations of any size and from any industry may create and follow an EMS. The International Organization for Standardization has established a set of standards and guidelines called ISO 14001-2004 that are directed to EMSs. An organization may adhere to these standards to help it become ISO 14001-2004 certified.

ISO certification is valuable to an organization for a variety of reasons. An organization that implements an EMS is likely to reduce its consumption of fossil fuels, optimize its use of resources, reduce its production of waste, and lower its operating costs. Additionally, manufacturers that are ISO 14001-2004 certified will gain a competitive advantage in government and private sector contracts where points are awarded to certified contractors. An organization may also improve its reputation within a community or with its stakeholders by having a certified EMS.

ISO 14001-2004 does not set levels of environmental performance that an EMS must meet to receive certification; rather, it requires that an EMS meet systematic standards so that it reduces the severity of an organization's environmental impacts over time. The organization must establish, document, implement, and continually improve its EMS, and to receive certification, it must also demonstrate that the EMS meets the requirements of every one of seventeen ISO 14001-2004 elements. These elements are listed below and briefly described in Table 1.

TABLE 1
The Seventeen ISO 14001-2004 Elements.

| ISO 14001- | |
|---|---|
| 2004 Element | Description of Element |
| Environmental Policy | Develop a statement describing the organization's |
| | commitment to the environment |
| Environmental | Identify how the organization's products, activities, |
| Aspects and Impacts | and services affect the environment |
| Legal and Other | Identify and ensure access to relevant laws and |
| Requirements | regulations |
| Objectives and Targets | Set environmental goals for the organization and |
| and Environmental | plan actions to achieve the organization's |
| Management Program | environmental objectives and targets |
| Structure and | Establish roles and responsibilities within the |
| Responsibility | organization with respect to the EMS |
| Training, Awareness, | Ensure that employees are aware and capable of |
| and Competence | their environmental responsibilities |
| Communication | Develop processes for internal and external |
| | communication regarding environmental |
| | management issues |
| EMS Documentation | Maintain information about the EMS and |
| | any related documents |
| Document Control | Ensure effective management of procedures |
| | and other documents |
| Operational Control | Identify, plan, and manage the organization's |
| | operations and activities in line with the policy, the |
| | objectives and targets, and significant aspects |
| Emergency | Develop procedures for preventing and |
| Preparedness and | responding to potential emergencies |
| Response | |
| Monitoring and | Monitor key activities and track the activities |
| Measuring | performance, including periodic compliance |
| | evaluations |
| Evaluation of | Develop a procedure to periodically evaluate |
| Compliance | compliance with legal and other requirements |
| Nonconformance and | Identify and correct problems and prevent |
| Corrective and | recurrences |
| Preventive Action | |
| Records | Keep adequate records of EMS performance |
| EMS Audit | Verify periodically that the EMS is effective and |
| | achieving objectives and targets |
| Management Review | Review the EMS |

The organization must show objective evidence which can be audited to demonstrate that the EMS is operating effectively in conformity with the ISO 14001-2004 standards, and must subject its EMS to independent auditing to receive certification. To develop an EMS that will withstand an audit, an organization typically hires consultants who spend an extended period of time with the organization, and who mold the organization's EMS until it meets the requirements of ISO 14001-2004. This process is generally slow and expensive. The consultants must learn a considerable amount about the organization's operations, which typically disrupts the operations, and they must develop training materials and train employees. Thus, while ISO 14001-2004 certification will provide extensive benefits to an organization, the organization may not seek to develop an EMS that meets ISO 14001-2004 standards because of the costs involved with doing so.

### BRIEF DESCRIPTION OF THE DRAWINGS

FIG. 1 is a diagram of a suitable environment in which an EMS training manager operates.

FIG. 2 is a block diagram of an EMS training manager that includes a training material generator.

FIG. 3 is a flow diagram depicting steps performed by the training materials generator to select training materials.

FIG. 4 is a table depicting example gap analysis questions.

FIG. 5 is a bar graph depicting example gap analysis results for various ISO 14001-2004 elements.

FIG. 6 is a diagram depicting a representative aspects and impacts inquiry tree.

FIG. 7 is a representative interface of a dashboard that is generated by the EMS training manager to enable task and financial monitoring.

### DETAILED DESCRIPTION

A method and system are described that optimizes the delivery of training materials to an organization that seeks to implement an environmental management system (EMS) meeting the requirements of a standard (such as the ISO 14001-2004 standard) (hereinafter the “EMS training manager”). The EMS training manager generates an optimized set of training materials for an organization based on two analyses. The EMS training manager presents gap analysis questions pertaining to the elements of the standard (e.g., the 17 elements of ISO 14001-2004) to an organization. Responses received to the gap analysis questions are used to calculate a gap analysis score with respect to each of the elements. The EMS training manager also presents aspects and impacts inquiries in a cascaded fashion, meaning that certain aspects and impacts inquiries are presented based at least in part on responses received to previous aspects and impacts inquiries. The EMS training manager generates optimized training materials for the organization by filtering a set of training modules based at least in part on the gap analysis scores and the aspects and impacts responses. While the description herein specifically addresses ISO 14001-2004 requirements, it will be appreciated that the EMS Training Manager may be applied to any prior, contemporaneous, or subsequent environmental standards or guidelines that may be promulgated.

In some embodiments, the EMS training manager further filters the training modules based at least in part on city, county, state, federal, or other regulations. In some embodiments, the EMS training manger further filters the training modules based at least in part on organization information (information describing or characterizing the organization). In some embodiments, a user responds to a gap analysis question by rating the extent to which the organization or an EMS associated with the organization conforms to the question.

In some embodiments, the EMS training manager further tracks an organization's progress toward implementing an EMS that complies with ISO 14001-2004 requirements. The EMS training manager monitors the presentation of training materials pertaining to the EMS. The EMS training manager also monitors the completion status of at least one task that is derived from the training materials. The EMS training manger also monitors a degree of completion of a task that is derived from the training materials. A progress report is generated by the EMS training manager and provided via a dashboard interface. The progress report indicates the organization's progress toward implementing an EMS that complies with the requirements of ISO 14001-2004.

In some embodiments, the EMS training manager receives financial data that pertains to the organization and/or the EMS. The EMS training manager uses the received financial data to provide a cost associated with each task monitored by the EMS training manager. The EMS training manager also uses the received financial data to provide an overall cost estimate of implementing the EMS that complies with ISO 14001-2004 requirements. In some embodiments, the progress report may include cost-savings estimates associated with implementing the EMS that complies with ISO 14001-2004.

The EMS training manager described herein allows an organization to implement an EMS at a minimal cost and with minimum disruption to the operations of the organization. The EMS training manager optimizes an organization's internal resources that are spent developing an EMS, and further obviates the need for expensive and disruptive external consulting that has historically plagued an organization's development of an EMS.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

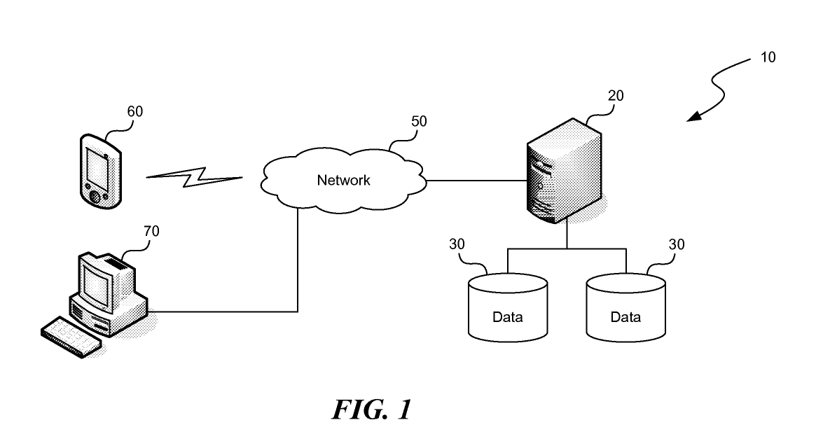

FIG. 1 depicts an environment in which an EMS training manager 10 operates. The EMS training manager operates on one or more servers 20 or other computing devices that have a processor and a memory. The servers 20 are connected to one or more data storage areas 30. Data storage areas 30 contain data pertaining to an EMS, such as regulations and training materials, as well as data related to an organization, such as company information, company processes data, and company activities data. Data storage areas 30 also contain software routines necessary to implement the technology disclosed herein. The data may be tangibly stored in any computer storage medium, such as hard drives, optical drives, tape drives, flash memory, etc. The servers 20 are also connected to one or more finance and task management systems (not shown) of the organization.

The EMS training manager 10 generates a dashboard interface and a training interface. The dashboard interface allows a user to monitor an organization's progress toward implementing an ISO 14001-2004 certified EMS, and the training interface allows a user to view training materials. A user may access the dashboard interface and the training user interface via mobile devices 60 or computers 70 that communicate with servers 20 through public or private networks 50, such as the Internet. In some embodiments, the EMS training manager 10 operates exclusively on a mobile device or computer, and data related to the organization and data pertaining to the EMS are stored locally on the mobile device or computer.

Those skilled in the art will appreciate that the EMS training manager 10 may be implemented on any computing system. Suitable computing systems include personal computers, server computers, hand-held or laptop devices, multiprocessor systems, microprocessor-based systems, network devices, minicomputers, mainframe computers, distributed computing environments that include any of the foregoing, and the like. Such computing systems may include one or more processors that execute software to perform the functions described herein. Processors include programmable general-purpose or special-purpose microprocessors, programmable controllers, application specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical based disks, flash memory devices, or any other type of non-volatile storage medium for storing data. Software may include one or more program modules which include routines, programs, objects, components, data structures, and so on that perform particular tasks or implement particular abstract data types. The functionality of the program modules may be combined or distributed across multiple computing systems or devices as desired in various embodiments.

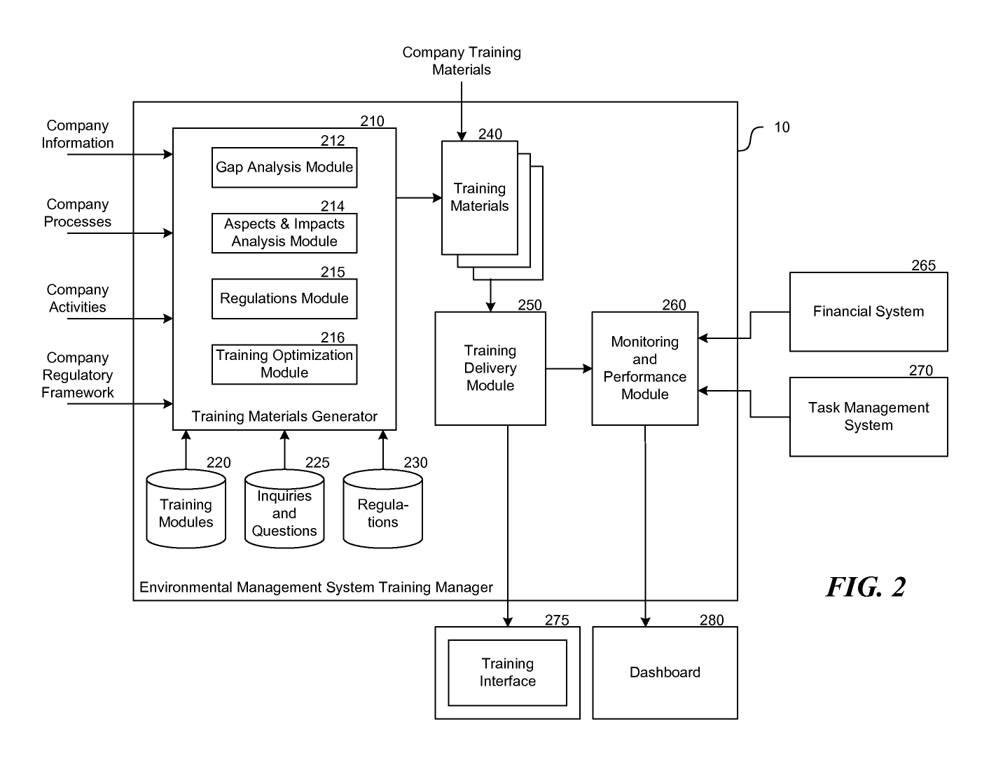

FIG. 2 is a block diagram of the EMS training manager 10. The EMS training manager 10 generates and delivers a set of customized training materials that are used by an organization seeking to implement an environmental management system (EMS) that meets a desired standard (such as the ISO 14001-2004 requirements). The training materials generated by the EMS training manager determine how users associated with an organization, such as employees and managers, are trained. The training manager includes a training materials generator 210, which generates training materials appropriate for the users associated with the organization. The training materials generator includes a gap analysis module 212, an aspects and impacts analysis module 214, a regulations module 215, and a training optimization module 216, each of which will be described in greater detail herein. The training materials generator 210 receives company information input, company processes input, company activities input, and company regulatory framework input, and accesses training materials from stored training modules in a data storage area 220 and regulations from stored regulations in a data storage area 230, and produces training materials 240 that are tailored for the organization.

A gap analysis is an analysis of the current performance of an organization in each of the areas that are measured by the environmental standard. The gap analysis seeks to identify and quantify performance in those areas in which the organization is excelling (perhaps meeting the standard), and those areas in which the organization is failing to meet the standard. The gap analysis module 212 of the training materials generator 210 presents a series of questions to an organization that are designed to elicit information about the organization. Based on the received answers to the questions, the gap analysis module calculates an organization's gap analysis scores for each of the seventeen ISO 14001-2004 elements and any additional subelements. Gap analysis scores define the extent to which an EMS of the organization meets the requirements of each ISO 14001-2004 element.

In addition to the gap analysis of the current performance of the organization in the areas identified by the standards, the training materials generator 210 also identifies specific processes or activities of the organization that have an environmental impact (whether positive or negative). The “aspects and impacts” analysis module 214 determines what activities of the organization create a potential environmental impact by the organization. For example, through a series of inquiries posed to the organization, the aspects and impacts analysis module may analyze company processes associated with a vehicle maintenance shop, and may determine that because the vehicle maintenance shop replaces asbestos break pads, an applicable aspect is solid waste that is generated and an applicable impact is that the waste may potentially be released to the environment.

The regulations module 215 identifies regulations that are applicable to the organization and its activities. Through a series of questions posed to the organization, the regulations module 215 identifies any regulatory frameworks that are applicable to the organization. For example, the regulations module may ask an organization to document the environmental permits or licenses that it maintains or must comply with. Also, for example, the regulations module 215 asks the organization whether it generates, emits, or discharges wastewater, air emissions or hazardous waste. The regulations module 215 accesses regulations stored in a data storage area 230 to identify specific federal, state, county, city, etc., regulations that are applicable to the organization within the identified frameworks.

The series of questions and inquiries presented to the organization by the gap analysis module 212, the aspects and impacts analysis module 214, and the regulations module 215 are derived from inquiries, questions, and other data stored in data storage area 225.

The training optimization module 216 selects training materials 240 from a set of training modules stored in data storage area 220. Training materials cover planning, implementation, monitoring, and measurement of all seventeen elements of the ISO 14001-2004 standards. The training optimization module 216 selects training materials 240 that are appropriate for the organization by considering the organization's gap analysis scores and aspects and impacts applicable to the organization. In practice, the identified training materials 240 may be supplemented by company training materials that are already in existence. The training optimization module 216 may also take into account any regulations controlling the organization. For example, if the training optimization module determines that a vehicle maintenance shop is subject to strict asbestos regulations, and the shop receives a low gap analysis score under the Training, Awareness, and Competence element, the training optimization module may generate training materials that help the organization implement a system to train employees about their roles in supporting the EMS, as well as activity specific issues such as use of hazardous substances, management of waste, or the like. Such general materials may further be tailored to ensure compliance with the laws of the particular region (e.g., city, state, nation) in which the organization is situated.

The EMS training manager 10 also includes a training delivery module 250 and a monitoring and performance module 260. The training delivery module receives the training materials 240 generated by the training materials generator and delivers the training materials to a user or users via a training interface 275. The training delivery module may also provide the training materials to the monitoring and performance module 260. The training delivery module 250 presents the training materials to the training interface in a predetermined order or in a user-specified order. The order may be based, for example, on an organization's need to address a specific element of the seventeen ISO 14001-2004 elements, which may be measured by gap analysis scores generated by the gap analysis module 212. In some embodiments, training materials are ordered in a manner designed to maximize their effectiveness. The training materials may be ordered, for example, based on content in the training materials (e.g., simple to complex) or based on a trainee's skill level.

The training interface 275 is displayed on a computer, mobile device, or the like, which is capable of displaying training materials to a user and receiving user feedback. For example, the training interface 275 may be included as part of a computer system that an employee accesses to receive environmental management training. In some embodiments, users receive training materials over a network, such as the Internet.

The monitoring and performance module 260 monitors data associated with an EMS, such as the cost of implementing an EMS and progress of an organization toward implementing an EMS that conforms with the requisite standards. The monitoring and performance module 260 also evaluates the organization based on various metrics associated with an EMS, including environmental metrics, operational metrics, management metrics, and/or financial metrics. For example, the monitoring and performance module may monitor an amount of water or chemical used by an organization per product produced. Using water-use or chemical-use data collected over a period that the organization implements an EMS, the monitoring and performance module determines the impact of the EMS on the organization's consumption of water, chemicals, or hazardous substances. This data may be compared to goals of the organization or to use data of other organizations to evaluate a relative impact of the EMS on the organization.

The monitoring and performance module generates a dashboard 280 that allows an organization to monitor the various metrics associated with the EMS as well as the costs and progress towards achieving compliance with the standard. To monitor the delivery of training materials, the monitoring and performance module 260 receives data from the training delivery module 250. To monitor the various metrics associated with the EMS, the monitoring and performance module 260 receives data from a financial system 265 and a task management system 270 of the organization.

Similarly, to monitor the progress of tasks associated with the training and the cost of the training, the monitoring and performance module 260 receives data from the financial system 265 and the task management system 270. The monitoring and performance module determines costs associated with implementing the EMS, costs associated with tasks that the organization has completed or tasks that remain incomplete, and cost savings associated with the EMS or specific tasks. A task is an undertaking by the organization to train certain organization members using the training materials 240 and to change the processes within the organization so that the organization is closer to meeting certification standards. The monitoring and performance module 260 may compute a projected cost and cost savings analysis associated with a task that the organization has yet to complete. Similarly, the monitoring and performance module 260 may examine a budget associated with the organization's operations to determine a priority among a number of various tasks the organization may implement.

The financial system 265 organizes financial data associated with the organization and with the EMS implemented by the organization. The financial system 265 accesses accounting records and any other financial records associated with the organization, such as projected budgets. The task management system 270 monitors steps that the organization has taken in light of training materials that the organization has received. For example, training materials may require that an organization complete a series of tasks related to an ISO 14001-2004 element. The task management system monitors both the degree to which the organization has completed a task of the series of tasks and the organization's progress toward completing the series of tasks. For example, a series of tasks may be required to be executed in a particular sequence in order for the organization to receive a desired environmental permit. The task management system 270 collects data associated with the tasks being implemented by the organization, uses the data to monitor the organization's completion of the tasks necessary to achieve the permit, and provides reports which specify the progress of the organization toward obtaining the permit. The task management system 270 also collects data pertaining to the various metrics associated with the EMS, such as a volume of water or an amount of a chemical used by the organization per product produced.

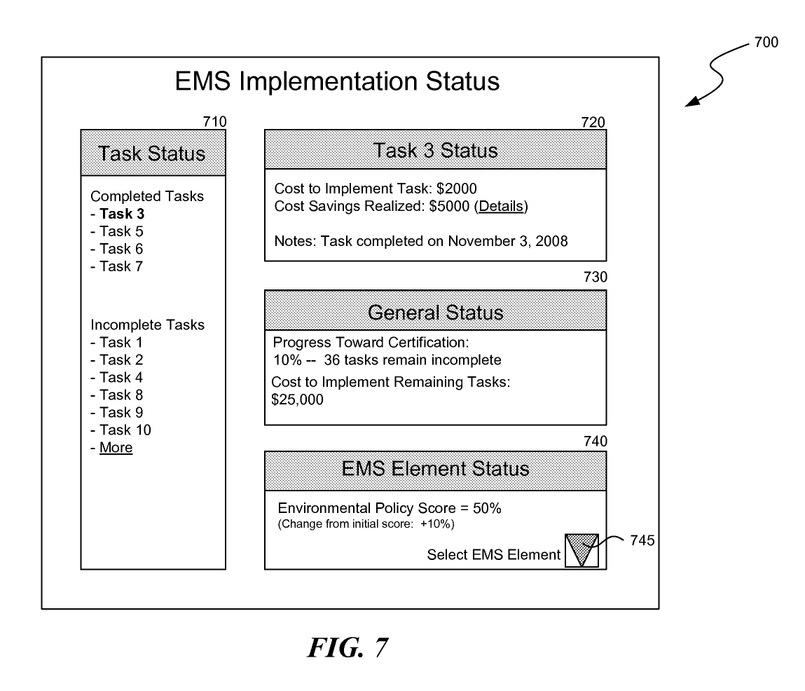

The monitoring and performance module 260 generates a dashboard 280 user interface that may be accessed by a user to monitor the organization's environmental performance and its progress toward certification of the EMS. Such progress may include, for example, an organization's progress towards obtaining certain permits. The dashboard 280 may be accessed by a computer, mobile device, or the like. In some embodiments, a user accesses the dashboard 280 over a network, such as the Internet. The dashboard's features are discussed more thoroughly below with respect to FIG. 7.

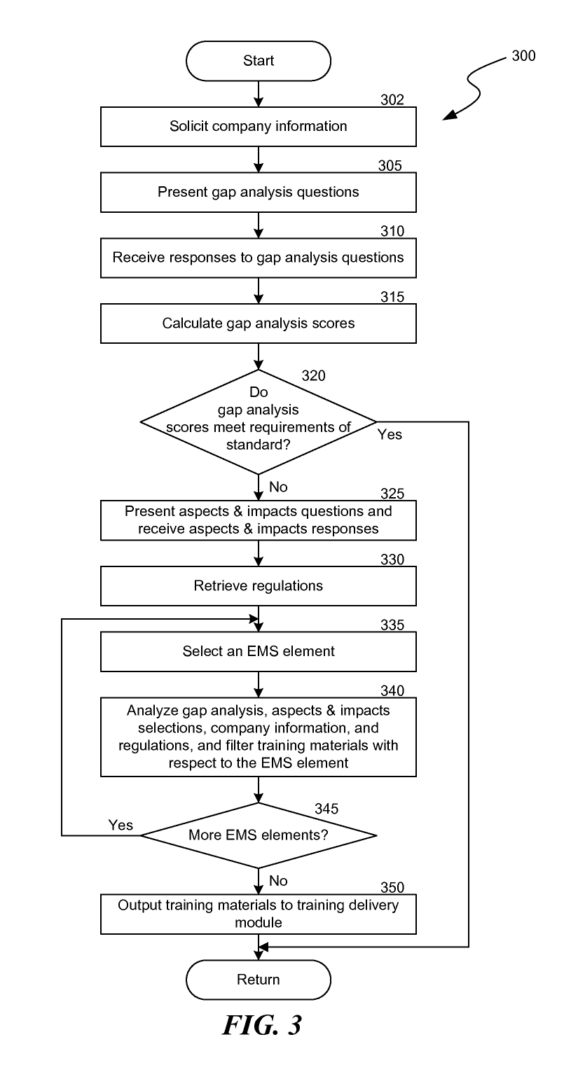

FIG. 3 is a flow diagram of a process 300 implemented by a training materials generator 210 of an EMS training manager 10 to select training materials for an organization. At a block 302, the training materials generator 210 solicits company information. The training materials generator 210 presents a series of questions to a user in order to elicit information about the company. Company information may include an industry that the organization is associated with, an address of the organization, products that are produced or sold by the organization, services that are offered by the organization, a number of employees, a characterization of the organization's facilities (e.g., number, square footage, location), divisions within an organization, or any other information that is related to the organization. The questions that are presented to the user may be multiple choice questions, true/false or yes/no questions, questions that solicit a textual response from the user, or other similar question forms.

At a block 305, the training materials generator 210 presents gap analysis questions to a user associated with the organization. Gap analysis questions may be presented on a computer, mobile device, or the like. Gap analysis questions are designed to gauge the extent to which the organization has implemented an EMS that complies with the applicable standards, such as the ISO 14001-2004 standard. For example, gap analysis questions may be directed toward the seventeen elements of ISO 14001-2004, with multiple questions being directed to each element.

In some embodiments, a gap analysis question is directed to more than one of the seventeen ISO 14001-2004 elements. For example, a gap analysis question may be directed toward both the Communication element and the EMS Documentation element. In some embodiments, gap analysis questions are directed to subelements of at least one of the seventeen ISO 14001-2004 elements.

At a block 310, the training materials generator 210 receives responses to the gap analysis questions. The user may utilize a keypad, keyboard, mouse, microphone, touchpad, touch screen, or the like to respond to gap analysis questions. The user may respond to a question by indicating “Yes” or “No,” by providing a specific response elicited by the question, by scoring on a scale an extent to which the organization has addressed a subject of the gap analysis question, or by describing how the organization has addressed the subject of the gap analysis question.

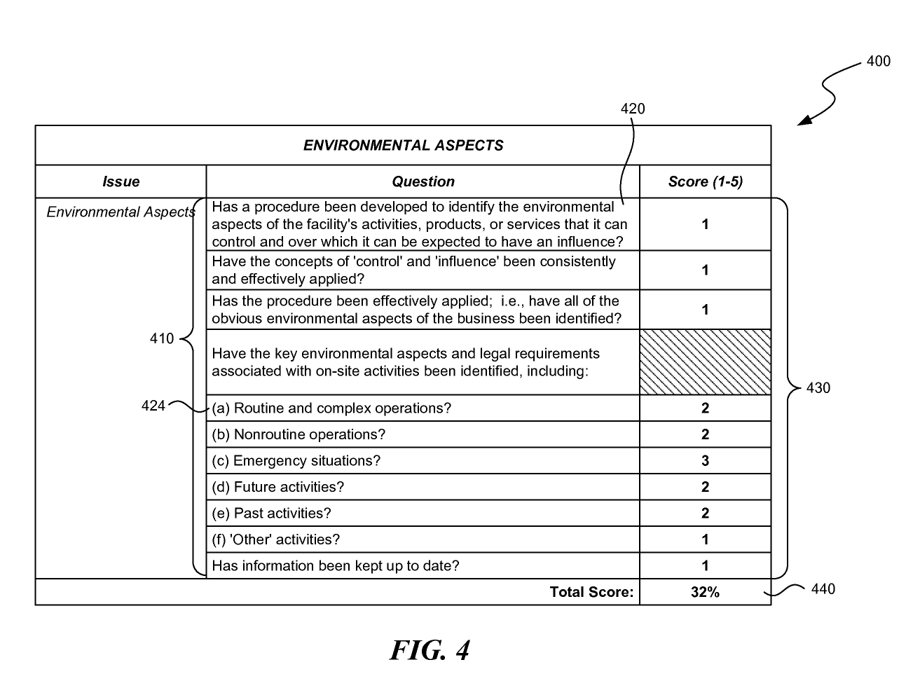

FIG. 4 is a table 400 showing representative gap analysis questions 410 and responses 430 to the questions that are provided by users. The table 400 is directed to “Environmental Aspects,” which is a subelement of the ISO 14001-2004 element entitled “Environmental Aspects and Impacts.” A representative first question 420, for example, asks the user, “Has a procedure been developed to identify the environmental aspects of the facility's activities, products, or services that it can control and over which it can be expected to have an influence?” The table has a column containing responses 430 that are submitted by one or more users. A user can respond to each question with a numerical score on a scale from one to five. A score of five indicates that the organization already thoroughly addresses the subject of the question, while a score of one indicates that the organization has yet to address the subject of the question. A score between one and five indicates a relative amount, between thoroughly and not at all, that the organization has addressed the subject of the question. For example, the user responded to the representative first question 420 with a score of one, indicating that the organization has not developed a procedure to identify environmental aspects of a facility's activities, products, or services that it can control and over which it can be expected to have an influence. However, in response to a representative fourth question 424, the user responded with a score of two, indicating that the organization has at least begun to identify key environmental aspects and legal requirements associated with routine and complex operations.

In some embodiments, the training materials generator quantifies a user's response to a gap analysis question to correspond to a score or ranking. For example, a gap analysis question may ask whether an organization has established and maintained a document control procedure. A user may respond that a document control procedure was established two years earlier, but it has not been maintained since. The training materials generator may quantify this response by scoring the response on a scale from one to five. Since the document control procedure was established but not maintained, the training materials generator may quantify the response to the gap analysis question as a three on a scale from one to five.

Returning to FIG. 3, the process 300 continues at a block 315. At block 315 the training materials generator calculates gap analysis scores for each of the seventeen ISO 14001-2004 elements. If the training materials generator presents gap analysis questions at block 405 that pertain to a subelement of one of the seventeen ISO 14001-2004 elements, the training materials generator also calculates a gap analysis score for the subelement.

A gap analysis score for an ISO 14001-2004 element is calculated by the training materials generator using the responses received to gap analysis questions at block 310. Gap analysis questions that pertain to a specific ISO 14001-2004 element affect a gap analysis score for that ISO 14001-2004 element. For example, in FIG. 4 the organization is scored on a scale from one to five for each question pertaining to an Environmental Aspects subelement. The training materials generator calculates a gap analysis score 440 for the Environmental Aspects subelement using the received scores. The gap analysis score 440 is calculated by adding the scores 430 received for each gap analysis question 410, dividing the sum by the highest possible score, and converting the resulting decimal into a percentage. The gap analysis score for the Environmental Aspects subelement has been calculated to be 32% because the aggregate of the gap analysis scores 430 is 16 and the highest possible score is 50 (10 questions with a maximum of 5 points for each question). Although the lowest possible score in FIG. 4 is 20%, in some embodiments, such as when gap analysis questions are scored from zero to five, the lowest possible score is 0%. In some embodiments, some gap analysis questions are weighted more heavily than other gap analysis questions when calculating a gap analysis score. In general, the following equation may therefore be used to calculate the gap analysis score for each element or subelement:

$$Score = \frac{{\sum }_{n = 1}^{m} W ( n ) * X ( n )}{{\sum }_{n = 1}^{m} W ( n ) * Max ( n )} * 100 , \qquad ( 1 )$$

where Score is a gap analysis score; W is a weight associated with a gap analysis question n, where n=1 corresponds to a first gap analysis question of a set of gap analysis questions; X is a score provided by a user in response to the gap analysis question n; Max is a maximum score possible as a response to the gap analysis question n; and in is the final gap analysis question out of the set of gap analysis questions.

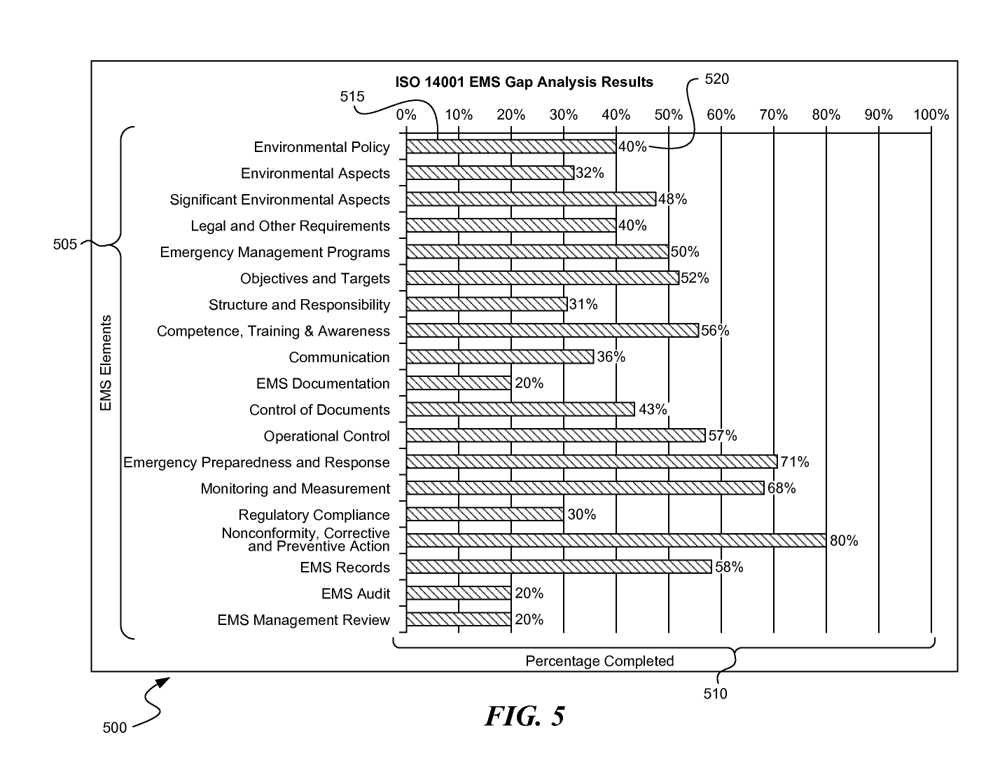

After calculating the gap analysis score for each element or subelement, the training materials generator may output an element scoring summary. FIG. 5 is a bar graph that is generated by the gap analysis module 212 and which graphically displays an element scoring summary 500. Labels 505 are aligned to the left of a scoring chart 510. The labels 505 describe nineteen total elements: the seventeen ISO 14001-2004 elements and two subelements. A bar 515 reflecting the corresponding gap analysis score extends to the right of each label on the scoring chart 510. In addition to the length of the bar representing the analysis score, a scoring indicator 520 provides a numerical indication of the gap analysis score for each of the nineteen elements. For example, the Environmental Policy element has a gap analysis score of 40%.

Returning to FIG. 3, at a decision block 320 the training materials generator determines whether the gap analysis scores calculated at block 315 are high enough for the organization to qualify for certification under the requisite standard. For example, to qualify for certification under ISO 14001-2004 the gap analysis scores calculated at block 315 must be 100% for all elements. If the organization does qualify for certification, the process 300 terminates. If the organization does not qualify for certification, the process continues at a block 325.

At block 325, the aspects & impacts analysis module 214 present aspects and impacts inquiries to the user and receives aspects and impacts responses from the user. Aspects and impacts inquiries are designed to determine specific processes, facilities, or activities of the organization that have an environmental impact (whether positive or negative). The aspects and impacts inquiries may be presented on a computer, mobile device, or the like, and the user may utilize a keypad, keyboard, mouse, microphone, touchpad, touch screen, or the like to respond to the aspects and impacts questions. An aspects and impacts inquiry may describe an activity, a facility type, a task, a process, a product, an industry, a chemical, or the like, and the user may respond with a “Yes” if the inquiry pertains to the organization and with a “No” if the inquiry does not pertain to the organization. For example, an aspects and impacts inquiry may ask whether the organization has a facility used to load aircraft fuel into trucks. If loading trucks with aircraft fuel pertains to the organization, the user may answer “Yes,” and if this activity does not pertain to the organization, the user may answer “No.” Aspects and impacts inquiries may solicit responses from users using the North American Industry Classification System (“NAICS”), the Standard Industrial Classification (“SIC”) system, or similar coding scheme. For example, an aspects and impacts inquiry may solicit a NAICS or SIC code from a user that describes certain activities or processes of the organization. In some embodiments, the aspects and impacts inquiries are filtered before any aspects and impacts inquiries are presented to a user. For example, the aspects and impacts analysis module 214 may filter aspects and impacts inquiries based on company information that was received at block 302 of FIG. 3. Those aspects and impacts inquiries that are unrelated to the organization's operations are removed by the aspects and impacts analysis module, and those inquiries that are more relevant to the organization's operations may be prioritized for presentation to the user over less relevant inquiries. Filtering the inquiries prior to presenting them to the user reduces the number of inquiries to which a user must respond.

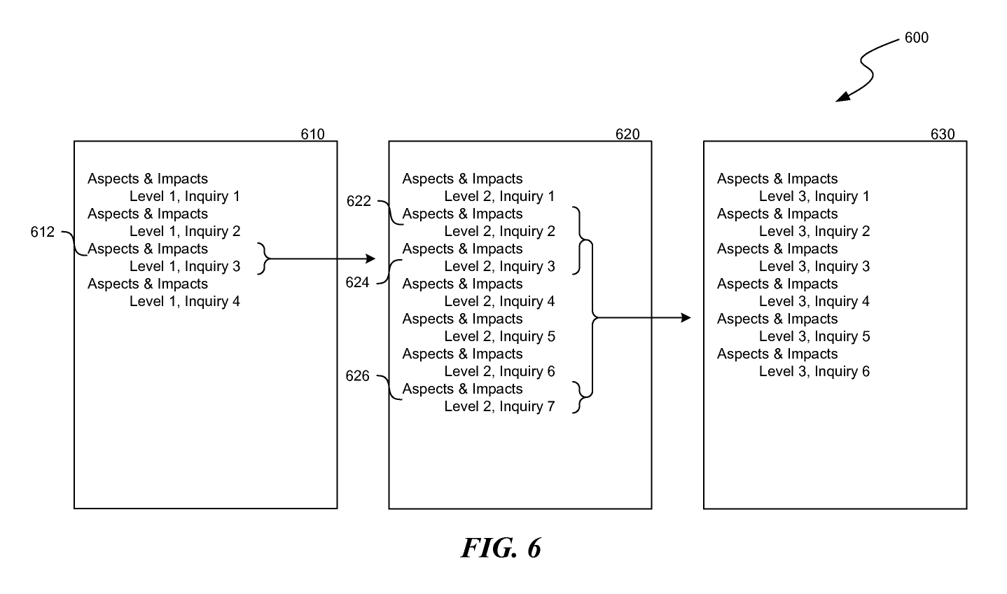

Aspects and impacts inquiries are presented as an inquiry tree, meaning that answers to one or more inquiries at a first level of questioning determine what inquiry or inquiries will be asked at a second level of questioning, and so on. FIG. 6 is a diagram showing a representative aspects and impacts inquiry tree 600. At a first level 610 of the aspects and impacts inquiry tree, four inquiries are presented to the user and four responses are received from the user. Based on an affirmative response to a third inquiry 612 of the first level of the aspects and impacts question tree, inquiries one through seven of a second level 620 of the aspects and impacts inquiry tree are presented to the user. Responses are then received at the second level 620 of the aspects and impacts inquiry tree. Based on affirmative responses to a second inquiry 622, a third inquiry 624, and a seventh inquiry 626, inquiries one through six of a third level 630 of the aspects and impacts inquiry tree are presented to the user.

Referring back to FIG. 3, following the receipt of aspects and impacts responses, the process 300 proceeds to a block 330. At block 330, the training materials generator receives or accesses any additional regulations that might be pertinent to the generation of training materials. Regulations may include international, federal, state, county, city or other regional or local regulations that apply to the organization. Regulations are stored in a data storage area and accessed by the training materials generator.

At a block 335, an element or subelement from the appropriate standard (e.g., ISO 14001-2004) is selected. At a block 340, the training materials generator filters training modules stored in the data storage area 220 in order to generate a set of training materials that pertain to the EMS element or subelement selected at block 335. The training modules are pre-existing training materials that are categorized, characterized, or grouped by topic or subject. When the training materials generator filters the training modules, the training materials generator selects certain pre-existing training modules that should be presented to the organization and omits other pre-existing training modules that should not be presented to the organization. The training materials generator filters the training modules based on the gap analysis scores pertaining to the selected element or subelement, responses to gap analysis questions, responses to the aspects and impacts inquiries, company information, and/or applicable regulations. To perform the filtration step, the EMS training manager may maintain a mapping (e.g., a matrix) which associates pre-existing training modules with potential responses, calculated scores, or information about an organization. For example, the mapping may associate different training modules with each potential gap analysis score that may be assigned to a corporation, or the mapping may associate different sets of training modules with particular responses to the aspects and impacts inquiries. The mapping enables the training materials generator to select or omit pre-existing training modules in an automated fashion.

In some embodiments, the training materials generator first filters the training modules based on responses to aspects and impacts inquiries. This initial filtering identifies the training materials that apply generally to organizations that implement similar processes, produce similar products, or have similar facilities as the organization. Next, the training materials generator filters the training modules based on company information and applicable regulations. This level of filtering identifies the training materials that apply based on a superficial analysis of the organization and its processes. Finally, the training materials generator filters the training modules based on responses to individual gap analysis questions and/or the gap analysis score for the EMS element or subelement selected at block 335. This final level of filtering identifies the training materials that address the deficiencies of the organization relating to the EMS element or subelement selected at block 335.

The training materials generator filters the training modules based on training that is needed at the organization for it to implement an EMS that conforms to the standard. For example, if the responses to the aspects to the impacts inquiries indicate that certain environmental aspects are not practiced by the facility, the pre-existing training modules pertinent to those aspects may be omitted from the training materials that are presented to the organization. As another example, if a gap analysis score indicates that a company has achieved an 80% score for the particular element or subelement, the training materials generator may omit basic training modules associated with that element or subelement in favor of advanced training modules. As still another example, if the company information indicates that a company has only 10 employees, and certain environmental regulations are not applicable to companies of that size, the training materials generator may omit training modules associated with those environmental regulations. In some embodiments, the training materials generator also considers the responses received to gap analysis questions, rather than merely the gap analysis scores, when filtering the training modules. The training modules are filtered based on what the organization must implement or change to achieve the desired certification.

At a decision block 345, the training materials generator determines whether an EMS element or subelement remains for which training materials have not been filtered. If an EMS element or subelement remains for which training materials have not been filtered, the process returns to block 335, and another EMS element is selected. If no EMS element or subelement remains, the process proceeds to a block 350. At block 350, the training materials generator outputs training materials to the training delivery module 250.

In some embodiments, an EMS training manager delivers training materials to an organization in stages. For example, in a first stage, the EMS training manager delivers training materials to 20% of the organization's staff over a four-day training period. In a second stage, the EMS training manager delivers training materials to the remaining 80% of the organization's staff over a customized one-, two-, three-, or four-day training period. During the first stage, a “Level One” EMS quality manual may be substantially completed, which the organization may reference while developing an EMS that fits into existing quality and business improvement systems, procedures, and policies of the organization. During the second stage, the EMS manual is completed and training emphasizes implementing the EMS manual. In some embodiments, training materials are delivered in groups, and each group relates to one of the elements of the standard (e.g., one of the elements of ISO 14001-2004). In some embodiments, the organization's staff that are trained in the first stage assist in training the organization's staff in the second stage.

FIG. 7 is a representative interface of a dashboard 700 that is generated by an EMS training manager. The dashboard 700 may be displayed on a computer, a mobile device, or the like. The dashboard shows information that enables an organization to monitor tasks and finances related to an EMS. A task summary region 710 is displayed on the dashboard, and describes tasks that have been completed and tasks that are incomplete. In some embodiments, the task summary region includes a description of completed and incomplete tasks.

A task from the task summary region 710 may be selected by a user so that information related to the task is displayed in a task detail region 720. The task detail region may include a description of the selected task, costs associated with the task, cost savings associated with the task, and any notes or other information associated with the task. In some embodiments, a user may select to view more details about the task, such as a degree to which the task is complete, when the task was completed, the steps taken to complete the task, the party that is responsible for the task, any preconditions or dependencies of the task, etc.

A general details region 730 includes information related to the EMS and to tasks generally. The general details region may display the organization's progress toward certification. Additionally, the general details region may display financial information, such as the cost to complete remaining tasks, or estimated cost-savings that the organization may realize by completing the remaining tasks. Furthermore, the general details region 730 may display cost savings associated with tasks that have been completed.

An EMS element status region 740 includes information related to an EMS element. As depicted in FIG. 7, the EMS element status region displays a current gap analysis score (“50%”) associated with a selected EMS element (“Environmental Policy Score”). The EMS element status region may also display a comparison between the current gap analysis score and the gap analysis score that was calculated by the gap analysis module before training materials were generated and presented to the organization. For example, the depicted region indicates that the current Environmental Policy Score has increased 10% from the initial score. In some embodiments, the EMS element status region 740 graphically displays gap analysis scores calculated before and after training has been implemented. For example, the EMS element status region may display a bar graph similar to the bar graph from FIG. 5 that includes gap analysis scores calculated before and after training materials have been followed by the organization. To allow a user to select a different EMS element to display, a drop-down menu control 745 is generated by the EMS training manager. When the user activates the control, the user may select an element to display from a list of all EMS elements.

Those skilled in the art will appreciate that the actual implementation of a data storage area may take a variety of forms, and the phrase “data storage area” is used herein in the generic sense to refer to any area that allows data to be stored in a structured and accessible fashion using such applications or constructs as databases, tables, linked lists, arrays, and so on. Those skilled in the art will further appreciate that the depicted flow charts may be altered in a variety of ways. For example, the order of the blocks may be rearranged, blocks may be performed in parallel, blocks may be omitted, or other blocks may be included.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A method for generating training materials that are followed to implement an environmental management system that meets an environmental standard, the method performed by a computing system having a processor and a memory, the method comprising:
presenting a plurality of gap analysis questions;
receiving responses to the plurality of gap analysis questions;
calculating at least one gap analysis score based on the response to the plurality of gap analysis questions, wherein calculating a gap analysis score is performed by the processor executing instructions stored in the memory;
presenting a plurality of aspects and impacts questions;
receiving responses to the plurality of aspects and impacts questions; and
generating training materials by filtering a set of training modules based on the at least one gap analysis score and the responses to the plurality of aspects and impacts questions, wherein generating training materials is performed by the processor executing instructions stored in the memory.

2. The method of claim 1, wherein the environmental standard is ISO 14001-2004.

3. The method of claim 1, further comprising receiving at least one regulation, wherein the training materials are further generated by filtering the set of training modules based on the at least one regulation.

4. The method of claim 1, further comprising receiving organization information, wherein the training materials are further generated by filtering the set of training modules based on the organization information.

5. The method of claim 2, wherein the plurality of gap analysis questions pertains to at least one element of ISO 14001-2004, and wherein the at least one gap analysis score pertains to the at least one element of ISO 14001-2004.

6. The method of claim 1, wherein the response to each of the plurality of gap analysis questions is a qualitative ranking that indicates a relative amount that an organization satisfies the question.

7. The method of claim 1, wherein the plurality of aspects and impacts questions are presented in a cascaded fashion.

8. The method of claim 2, wherein the training materials are directed to at least one ISO 14001-2004 element.

9. The method of claim 1, further comprising presenting the training materials to a user.

10. A system for generating training materials for implementing an environmental management system that meets an environmental standard, the system comprising:
a gap analysis module, the gap analysis module configured to:
present a plurality of gap analysis questions;
receive responses to the plurality of gap analysis questions; and
calculate at least one gap analysis score based on the response to the plurality of gap analysis questions;
an aspects and impacts analysis module, the aspects and impacts analysis module configured to:
present a plurality of aspects and impacts questions; and
receive responses to the plurality of aspects and impacts questions; and
a training optimization module, the training optimization module configured to filter a set of training modules based on the at least one gap analysis score and the responses to the plurality of aspects and impacts questions in order to generate training materials.

11. The system of claim 10, wherein the environmental standard is ISO 14001-2004.

12. The system of claim 10, wherein the training optimization module is further configured to receive at least one regulation, wherein the set of training materials are further generated by filtering the set of training modules based on the at least one regulation.

13. The system of claim 10, wherein the training optimization module is further configured to receive organization information, wherein the set of training materials are further generated by filtering the set of training modules based at least in part on the organization information.

14. The system of claim 11, wherein the plurality of gap analysis questions pertain to at least one element of ISO 14001-2004, and wherein the at least one gap analysis score pertains to the at least one element of ISO 14001-2004.

15. The system of claim 10, wherein the response to each of the plurality of gap analysis questions is a qualitative ranking that indicates a relative amount that an organization satisfies the question.

16. The system of claim 10, wherein the plurality of aspects and impacts questions are presented in a cascaded fashion.

17. The system of claim 11, wherein the training materials are directed to at least one ISO 14001-2004 element.

18. The system of claim 10, further comprising a training interface component, the training interface component configured to present the training materials to a user.

19. A method for tracking an organization's progress toward implementing an environmental management system that complies with a standard, the method performed by a computing device having a processor and a memory, the method comprising:
receiving training materials that pertain to an environmental management system of an organization;
receiving task information that describes a plurality of tasks derived from the training materials;
receiving task update information, wherein the task update information describes a status of at least one of the plurality of tasks, wherein the status indicates a degree of completion of a task;
generating a progress report that indicates a progress of the organization toward implementing an environmental management system that complies with the requirements of the standard, the progress report displaying the status of the plurality of tasks; and
presenting the progress report to a user;
wherein code implementing the method is stored in a memory of the computing system for execution by a processor of the computing system.

20. The method of claim 19, further comprising receiving financial data pertaining to each of the plurality of tasks, and wherein the progress report includes a cost associated with implementing each of the plurality of tasks.

21. The method of claim 20, wherein the progress report includes a projected cost of implementing the environmental management system that complies with ISO 14001-2004 standards.

22. The method of claim 20, wherein the progress report includes a cost-savings associated with implementing the environmental management system that complies with ISO 14001-2004 standards.

23. The method of claim 19, wherein the standard is ISO 14001-2004.
